(19) United States
(12) Patent Application Publication
(10) Pub. No.: US 2006/0062021 A1
(43) Pub. Date: Mar. 23, 2006

(54) Miniature decorative light bulb

(76) Inventor: Wei-Jen Tseng, Hsinchu (TW)

Correspondence Address: Jackson Walker L.L.P., Suite 2100, 112 E. Pecan Street, San Antonio, TX, 78205, US

(21) Appl. No.: 10/947,599

(22) Filed: Sep. 22, 2004

(51) Int. Cl. H01R 33/00

(52) U.S. Cl. 362/654

(57) ABSTRACT

The miniature decorative light bulb has a sealed bulb and an incandescent element. The bulb has a proximal end and an inverted conical distal end. The inverted conical distal end is formed inward into the bulb. The incandescent element is mounted inside the bulb and has electrical leads extending through the proximal end. When the incandescent element emits light, the inverted conical distal end reflects the light. Then the light is reflected through the wall and the light will be brighter.

### BACKGROUND OF THE INVENTION

1. Field of the Invention

The present invention relates to a light bulb, especially to a miniature decorative light bulb that emits bright light.

2. Description of the Prior Arts

With reference to FIGS. 10, 11 and 12, a conventional miniature decorative light bulb comprises a bulb (30) and an incandescent element (40). The bulb (30) has a conical protrusion (31). The conical protrusion (31) extends out longitudinally from the bulb (30). The incandescent element (40) is mounted inside the bulb (30) and has electrical leads protruding through the bulb (30). The light emitted by the incandescent element (40) passes through the bulb (30), radiates spherically from the bulb (30) and has an omnidirectional field of view and an intensity based on the distance (R) from the bulb (30). The intensity of the light is inversely proportional to the square of the distance (1/R²) from the bulb (30). However, most people are concerned with the intensity or brightness of the light rather than being able to see the light from all directions. Therefore the low brightness of the light is a disadvantage of the conventional miniature decorative light bulb.

To overcome the shortcomings, the present invention provides a miniature decorative light bulb to mitigate or obviate the aforementioned problems.

### SUMMARY OF THE INVENTION

The main objective of the present invention is to provide a miniature decorative light bulb that can focus the emitted light.

The miniature decorative light bulb in accordance with the present invention has a sealed bulb and an incandescent element. The bulb has a proximal end and an inverted conical distal end. The inverted conical distal end is formed inward in the bulb. The incandescent element is mounted inside the bulb and has electrical leads extending out of the proximal end of the bulb. When the incandescent element emits light, the inverted conical distal end reflects light emitted longitudinally in a radial direction relative to the bulb to make the light brighter in a radial direction.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a miniature decorative light bulb in accordance with the present invention;

FIG. 2 is a side view in partial section of the miniature decorative light bulb in FIG. 1;

FIG. 3 is a side view in partial section of the miniature decorative light bulb in FIG. 1 with the rays of light;

FIG. 4 is a perspective view of another miniature decorative light bulb in accordance with the present invention;

FIG. 5 is a side view in partial section of the miniature decorative light bulb in FIG. 4;

FIG. 6 is a side view in partial section of the miniature decorative light bulb in FIG. 4 with the rays of light;

FIG. 7 is a perspective view of another miniature decorative light bulb in accordance with the present invention;

FIG. 8 is a side view in partial section of the miniature decorative light bulb in FIG. 7;

FIG. 9 is a side view in partial section of the miniature decorative light bulb in FIG. 7 with the rays of light;

FIG. 10 is a perspective view of a conventional miniature decorative light bulb in accordance with the prior art;

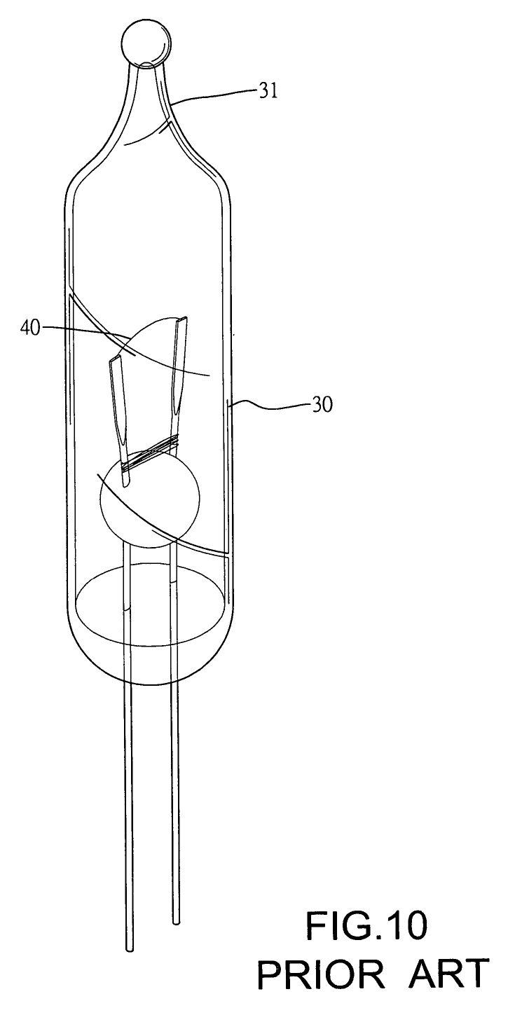

FIG. 11 is a side view in partial section of the conventional miniature decorative light bulb in FIG. 10; and

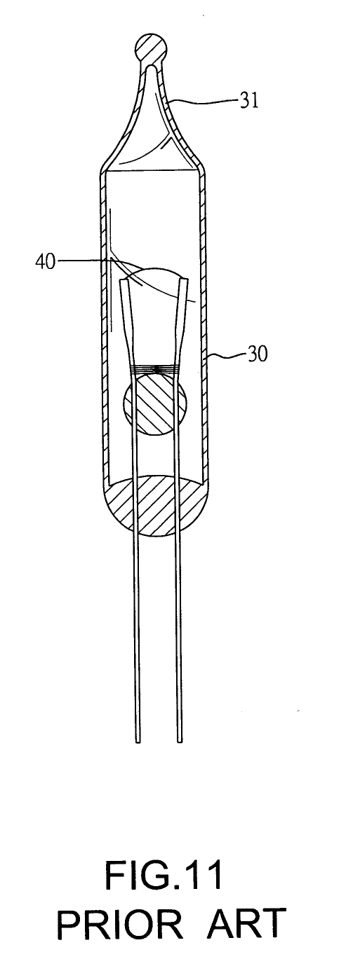

FIG. 12 is a side view in partial section of the conventional miniature decorative light bulb in FIG. 10 with the rays of light.

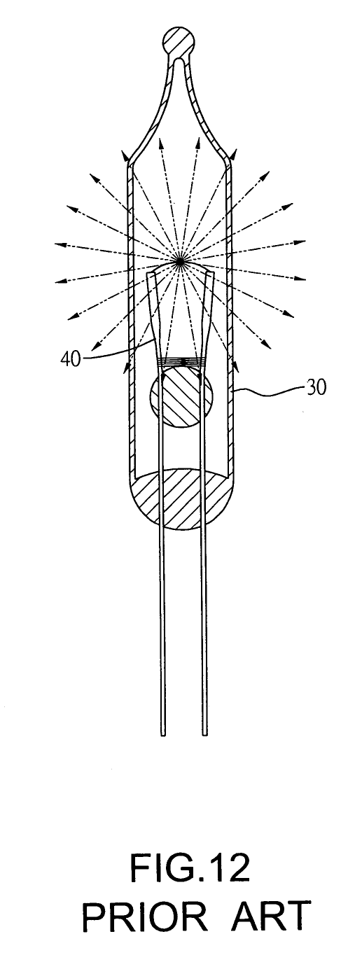

### DETAILED DESCRIPTION OF THE PREFERRED EMBODIMENTS

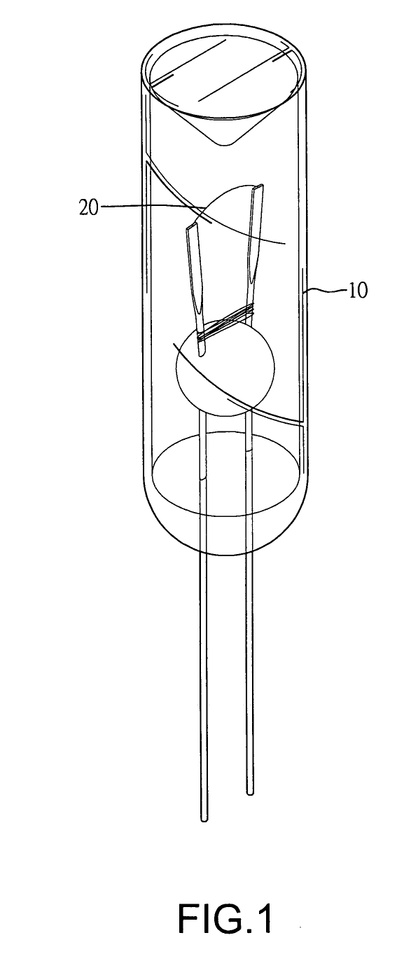

With reference to FIG. 1, a miniature decorative light bulb in accordance with the present invention comprises a bulb (10) and an incandescent element (20).

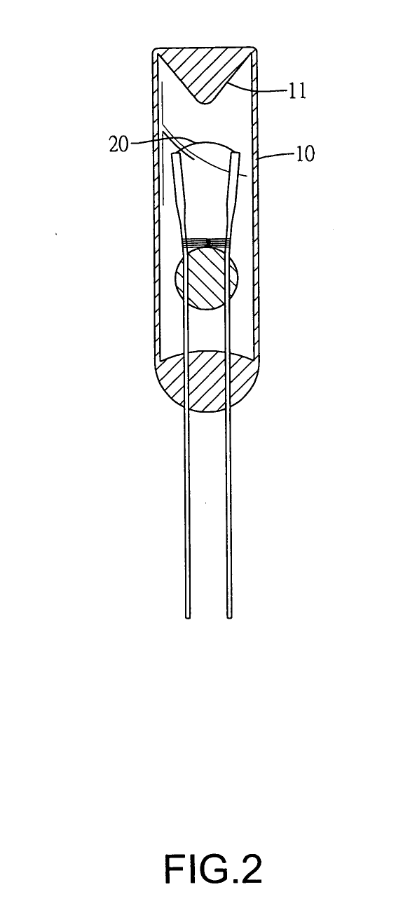

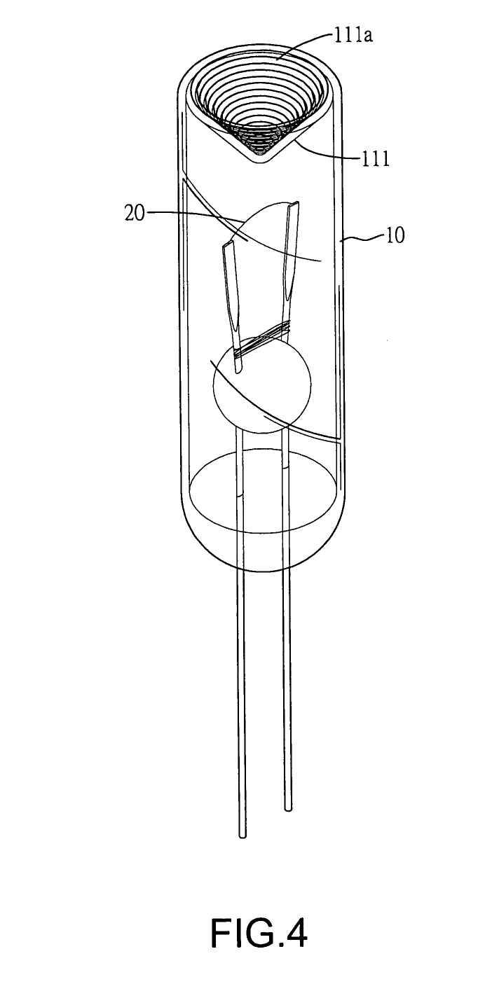

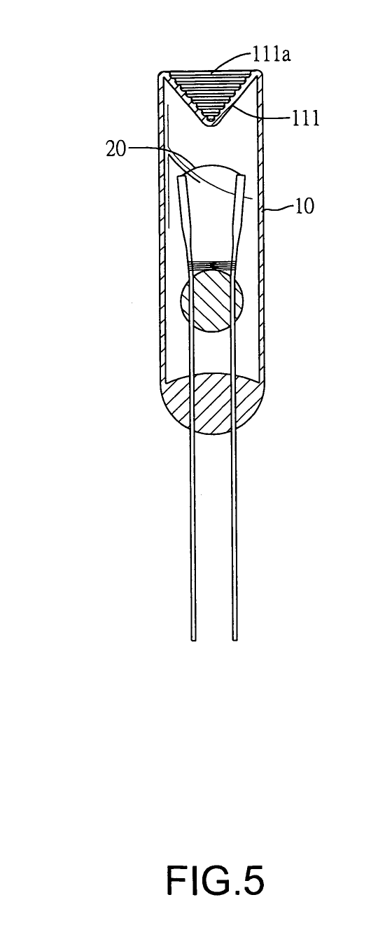

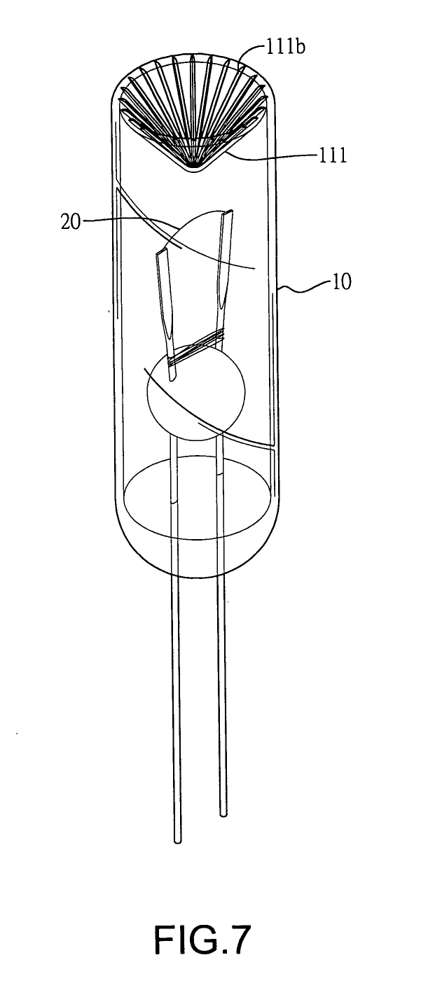

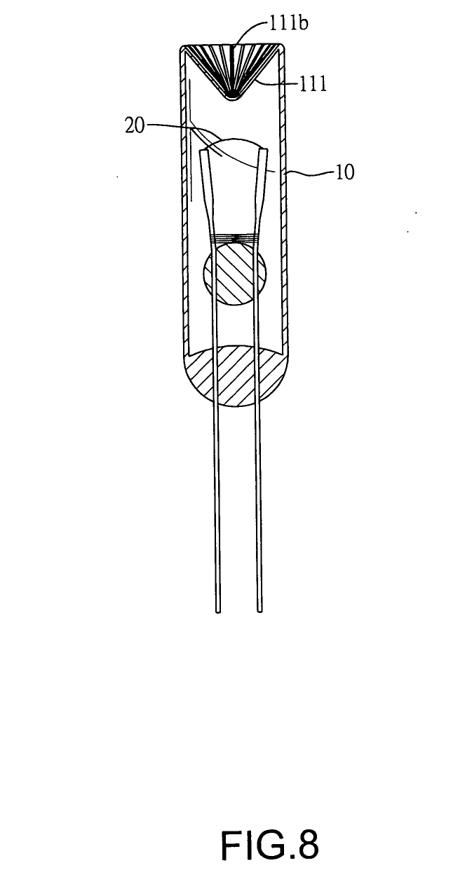

With further reference to FIGS. 2, 4, 5, 7 and 8, the bulb (10) is sealed and has a proximal end, an inverted conical distal end (11) and a wall. The inverted conical distal end (11) is formed and tapered inward into the bulb (10), may be either solid or hollow and may have multiple annular ribs (111a) or multiple radial ribs (111b). When the inverted conical distal end (11) is hollow, the inverted conical distal end (11) has a concave exterior surface.

In a third embodiment of the miniature decorative light bulb in accordance with the present invention, the multiple annular ribs (111a) are formed concentrically on the concave exterior surface of the inverted conical distal end (11).

In a fourth embodiment of the miniature decorative light bulb in accordance with the present invention, the multiple radial ribs (111b) are formed radially on the concave exterior surface of the inverted conical distal end (11).

The incandescent element (20) is mounted in the bulb (10), has electrical leads extending through the proximal end of the bulb (10) and radiates light having an intensity.

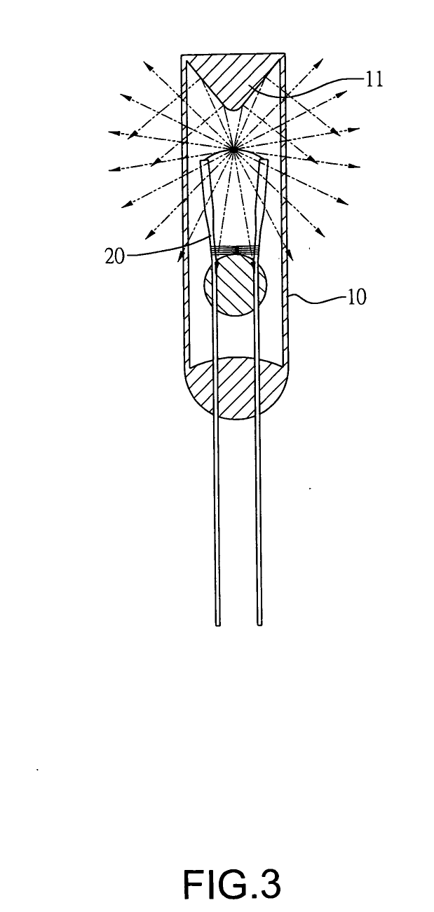

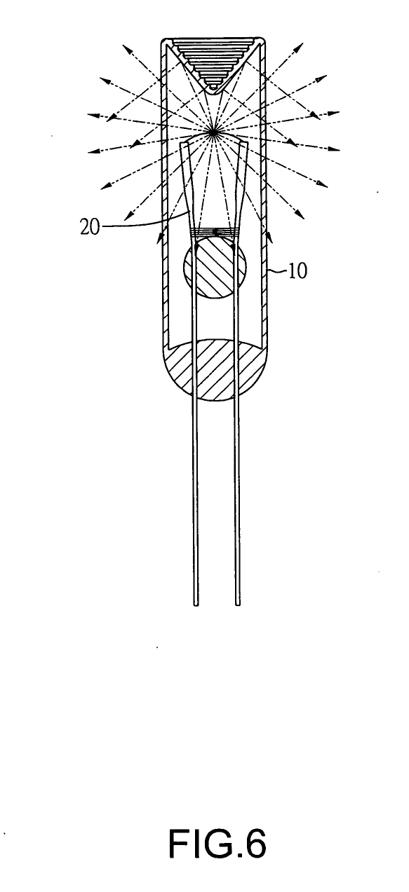

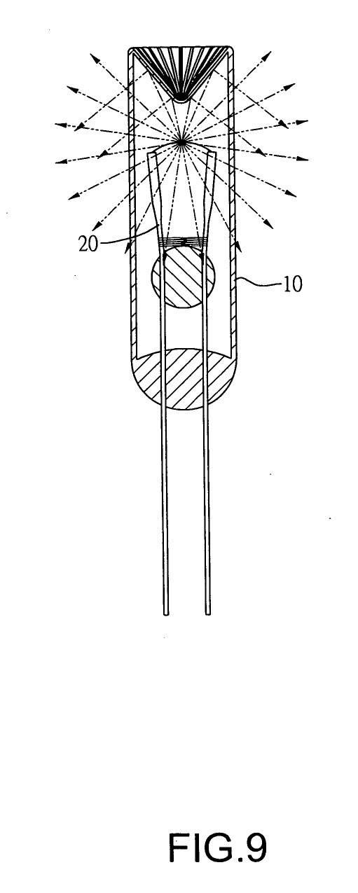

With further reference to FIGS. 3, 6 and 9, the light emitted from incandescent element (20) is reflected by the inverted conical distal end (11), the annular ribs (111a) and the radial ribs (111b) and reinforces the light radiating directly through the bulb (10). Therefore, the intensity of the light is greater when the bulb (10) is viewed from the wall, and the miniature decorative light bulb is brighter.

The miniature decorative light bulb as described has numerous advantages. Because the light has a greater intensity, the brightness of the light is increased. Then the user can get a brighter light bulb.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A miniature decorative light bulb comprising
a bulb being sealed and having a proximal end;
an inverted conical distal end formed inward in the bulb; and
a wall;
an incandescent element mounted in the bulb and having electrical leads extending through the proximal end of the bulb.

2. The light bulb as claimed in claim 1, wherein the inverted conical distal end of the bulb is solid.

3. The light bulb as claimed in claim 1, wherein the inverted conical distal end of the bulb is hollow and has a concave exterior surface.

4. The light bulb as claimed in claim 3, wherein the inverted conical distal end has multiple annular ribs formed concentrically on the concave exterior surface.

5. The light bulb as claimed in claim 3, wherein the inverted conical distal end has multiple radial ribs formed radially on the concave exterior surface.
